(19) United States
(12) Patent Application Publication
(10) Pub. No.: US 2016/0026421 A1
(43) Pub. Date: Jan. 28, 2016

(54) SMART NETWORK SYSTEM

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/753,667

(22) Filed: Jun. 29, 2015

(30) Foreign Application Priority Data
Jul. 25, 2014 (CN) 201410360833.9

(51) Int. Cl. G06F 3/14; G06F 3/0488; G06F 3/0485; G06F 3/0484; G06F 3/044; H04W 4/00

(52) U.S. Cl. CPC G06F 3/14; G06F 3/044; H04W 4/008; G06F 3/0485; G06F 3/04842; G06F 3/0488

(57) ABSTRACT

A smart network system comprises at least one addressing wireless display device and a smart slide-on-strap terminal device. The smart slide-on-strap terminal device communicates with the addressing wireless display device. The smart slide-on-strap terminal device comprises a body, a wireless module, a processing unit, and at least one slide-on-strap touch-sensing structure. The body has a strap. The wireless module is disposed on the body. The processing unit is coupled to the wireless module. The slide-on-strap touch-sensing structure is disposed on the strap and coupled to the processing unit. The slide-on-strap touch-sensing structure senses at least one trigger event to remotely control the addressing wireless display device. The disclosure is applied to the communication between the addressing wireless display device and the smart slide-on-strap terminal device to increase the applications of the smart slide-on-strap terminal device.

### CROSS REFERENCE TO RELATED APPLICATIONS

This Non-provisional application claims priority under 35 U.S.C. §119(a) on Patent Application No(s). 201410360833.9 filed in People's Republic of China on Jul. 25, 2014, the entire contents of which are hereby incorporated by reference

### BACKGROUND

1. Technical Field

The invention relates to a smart network system, in particular to a smart network applied to between an addressing wireless display device and a smart slide-on-strap terminal device.

2. Related Art

With the progress of technologies, various information devices having communication functions are continuously innovated, such as mobile phones, tablet computers, ultra-thin notebook computers, satellite navigation devices or the like. At present, due to advances in technology, the processors are continuously developed to be smaller size and the higher performance. Thus some wearable devices having the sizes much smaller than other communication devices are also developed to have communication functions and other functions as well.

Accordingly, products of smart wearable device, such as smart watches, smart bracelets or the like, have been developed and appear. In comparison with the conventional watch, the smart watch further comprises a positioning module capable of recording a position of the smart watch or the smart bracelet, and further comprises a transmission module capable of communicating with other electronic devices to obtain the activity records of the user while wearing the smart watch or the smart bracelet. However, either the smart watch or the smart bracelet has the small size, and thus has the restricted functions.

For example, although the current smart watch and smart bracelet can communicate with other electronic devices, they are only used in power transmission or data transmission to charge the smart watch or the smart bracelet. Or being designed to transmit the activity records of the users by the smart watch and the smart bracelet to other electronic devices, and no other utilities are provided. At present, in addition to the restricted functions, the overall appearance of the wearable smart device further needs to be broken through. In details, most input functions of the wearable smart device are executed through physical buttons, and the physical buttons need to be additionally disposed on the surface of the wearable smart device, thereby deteriorating the overall integrity

### SUMMARY

An aspect of the invention is to provide a smart network system applied to communication between an addressing wireless display device and a smart slide-on-strap terminal device to increase the applications of the smart slide-on-strap terminal device and even enhance the functions of the smart slide-on-strap terminal device by the smart network system, and to facilitate the overall integrity of the outlook of the smart slide-on-strap terminal device by disposing the slide-on-strap touch-sensing structure on the smart slide-on-strap terminal device. In details, the smart slide-on-strap terminal device has the slide-on-strap touch-sensing structure, which has the touch input function and is disposed on the strap, and a processing unit produces the corresponding operation instruction according to the user's input. A wireless module transmits the operation instruction to the addressing wireless display device to remotely control the electronic device, and to enhance the functions possessed by the smart slide-on-strap terminal device. Meanwhile, the design of the slide-on-strap touch-sensing structure can further need no more physical buttons, so that the overall integrity of the outlook of the slide-on-strap touch-sensing structure is maintained.

A smart network system comprises at least one addressing wireless display device; and a smart slide-on-strap terminal device. The smart slide-on-strap terminal device communicates with the addressing wireless display device. The smart slide-on-strap terminal device comprises a body, a wireless module, a processing unit, and at least one slide-on-strap touch-sensing structure. The body has a strap. The wireless module is disposed on the body. The processing unit is coupled to the wireless module. The slide-on-strap touch-sensing structure is disposed on the strap and coupled to the processing unit. The slide-on-strap touch-sensing structure senses at least one trigger event to remotely control the addressing wireless display device.

In one embodiment, the smart slide-on-strap terminal device comprises a smart bracelet, a smart watch, or a smart ring.

In one embodiment, the strap comprises a watchband of the smart watch, a strap of the smart bracelet or a circle of the smart ring.

In one embodiment, the slide-on-strap touch-sensing structure is a capacitive touch-sensing structure.

In one embodiment, a central line is disposed on a surface of the strap to divide the slide-on-strap touch-sensing structure into two touch-sensing areas to simulate functions of two physical buttons of a mouse.

In one embodiment, the trigger event comprises a trigger quantity, a trigger quantity distribution, a trigger morphology (which can refer to trigger appearance), a trigger time, a trigger location (which can refer to trigger position) or a trigger frequency.

In one embodiment, the processing unit receives a signal generated by the trigger event to execute an operation instruction.

In one embodiment, the wireless module receives and transmits the operation instruction to the addressing wireless display device

In one embodiment, the smart network system further comprises a wireless access point which communicates with the smart slide-on-strap terminal device and the addressing wireless display device. The wireless module of the smart slide-on-strap terminal device transmits display information corresponding to the operation instruction to the wireless access point, and the wireless access point transmits the display information to the addressing wireless display device.

In one embodiment, the processing unit produces the operation instruction according to a trigger time, a trigger track or a trigger frequency of the trigger event.

In one embodiment, if the trigger event occurs on the slide-on-strap touch-sensing structure, the trigger time is longer than or equal to a predetermined time, and the trigger track corresponds to one direction, then the processing unit produces the operation instruction for increasing or decreasing a volume.

In one embodiment, if the trigger event occurs on the slide-on-strap touch-sensing structure, the trigger time is longer than or equal to a predetermined time, and the trigger track corresponds to one direction, then the processing unit produces the operation instruction for increasing or decreasing a playback speed.

In one embodiment, if the trigger event occurs on the slide-on-strap touch-sensing structure, the trigger track comprises multiple trigger tracks having more than one direction, then the processing unit produces the operation instruction of one-dimensional screen scrolling, and direction of the one-dimensional screen scrolling is the same with the direction of multiple trigger tracks.

In one embodiment, if the trigger frequency of the trigger event conforms to a booting condition, then the processing unit produces an operation instruction for booting.

In one embodiment, the wireless module comprises an infrared module, a bluetooth module, a ZigBee module, a radio frequency module or a near-field communication module.

In one embodiment, the near-field communication module comprises a user identification key automatically linking to the addressing wireless display device by the wireless module.

In one embodiment, the wireless module comprises a wireless communication chip and an antenna, the wireless communication chip is electrically connected to the processing unit, and the antenna is disposed on the body or the slide-on-strap touch-sensing structure.

In one embodiment, the smart slide-on-strap terminal device comprises a charging module, and the wireless access point transmits a wireless charging energy to the charging module.

In one embodiment, the slide-on-strap touch-sensing structure comprises a driving circuit and a sensing circuit, the driving circuit is disposed inside the strap, and the sensing circuit is disposed on an outer surface of the strap.

In one embodiment, a portion of the sensing circuit on the outer surface of the strap has a protrusion, and the strap further comprises a protection layer covering the protrusion.

In summary, the user can perform the touch input by operating the smart slide-on-trap touch sensing terminal device to communicate with the addressing wireless display device. The user can perform the touch operation on the slide-on-strap touch-sensing structure disposed on the strap. Next, the processing unit produces the corresponding operation instruction, and the wireless module transmits the operation instruction to the addressing wireless display device to remotely control the addressing wireless display device. In other words, the smart slide-on-strap terminal device may be used as the smart remote controller to enhance the functions possessed by the smart slide-on-strap terminal device. The design of the slide-on-strap touch-sensing structure may also need no more physical buttons, and the overall integrity of the outlook of the slide-on-strap touch-sensing structure can be maintained. In addition, because the element of performing the touch operation is the slide-on-strap touch-sensing structure, the conventional physical button can be replaced, and the overall integrity and beauty of the outlook of the smart slide-on-strap terminal device can be upgrade, and the higher quality and more wonderful user experience can be achieved.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematic diagram showing the smart network system according to an embodiment of the invention;

FIG. 2A is a schematic enlarged diagram showing the smart slide-on-strap terminal device in FIG. 1;

FIG. 2B is a schematic block diagram showing the smart slide-on-strap terminal device in FIG. 1;

FIG. 3 is a schematic diagram showing the smart slide-on-strap terminal device according to another embodiment of the invention;

FIG. 4 is a schematic diagram showing operations of the slide-on-strap terminal device in FIG. 1;

FIG. 5A and FIG. 5B are schematic diagrams showing operations of the slide-on-strap terminal device in FIG. 1;

FIG. 6A and FIG. 6B are schematic diagrams showing operations of the slide-on-strap terminal device in FIG. 1;

FIG. 7A is a schematic diagram showing the smart slide-on-strap terminal device according to another embodiment of the invention; and

FIG. 7B is a schematic exploded diagram showing the smart slide-on-strap terminal device in FIG. 7A.

### DETAILED DESCRIPTION OF THE INVENTION

The embodiments of the invention will be apparent from the following detailed description, which proceeds with reference to the accompanying drawings, wherein the same references relate to the same elements.

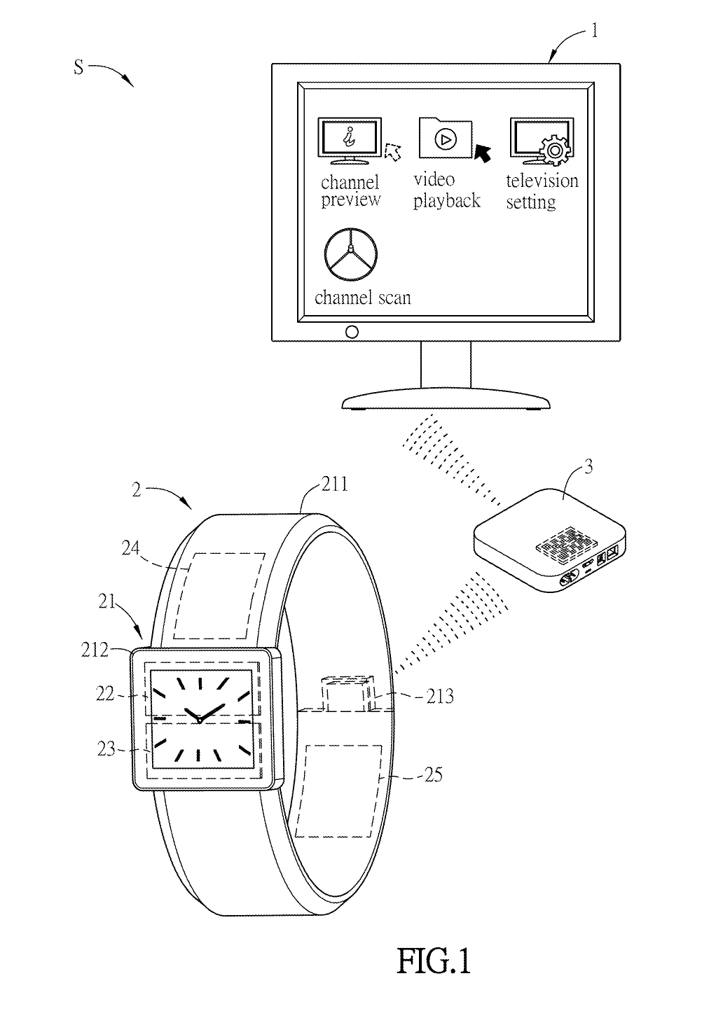

FIG. 1 is a schematic diagram showing the smart network system according to an embodiment of the invention. Referring to FIG. 1, the smart network system S comprises at least one addressing wireless display device 1 and a smart slide-on-strap terminal device 2. In the embodiment, the addressing wireless display device 1 is a display device having fixed domain name and position. In general, it is disposed at a stationary location and regarded as stationary display screen which is distinguish from the display screen of the hand-held electronic device (for example, mobile phone, tablet computer, etc.). The smart slide-on-strap terminal device 2 in the embodiment is applied to a wearable device, which may be directly worn by the user, and may comprise a smart bracelet, a smart watch, a smart ring or the like for example. The smart slide-on-strap device of this embodiment may also be a detachable wearable device, such as a device worn in the form of a necklace. However, it is not limited thereto. Thus, the smart slide-on-strap terminal device 2 of this embodiment also relates to an application of a small wearable electronic device with displaying and inputting functions. The “slide-on-strap” smart device of this embodiment is a device having a strap, such as a watchband of a smart watch, a strap of a smart bracelet or a circle of a smart ring, wherein a touch input can be performed on the strap. Next, the smart slide-on-strap terminal devices 2 of the following embodiments are described as the smart watch, the smart bracelet and the smart necklace serving as examples.

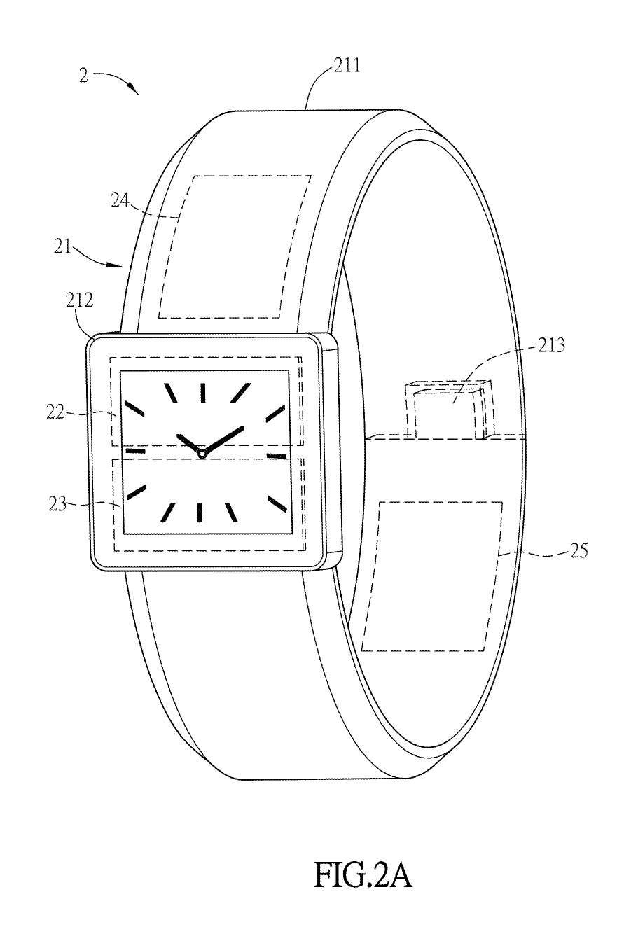

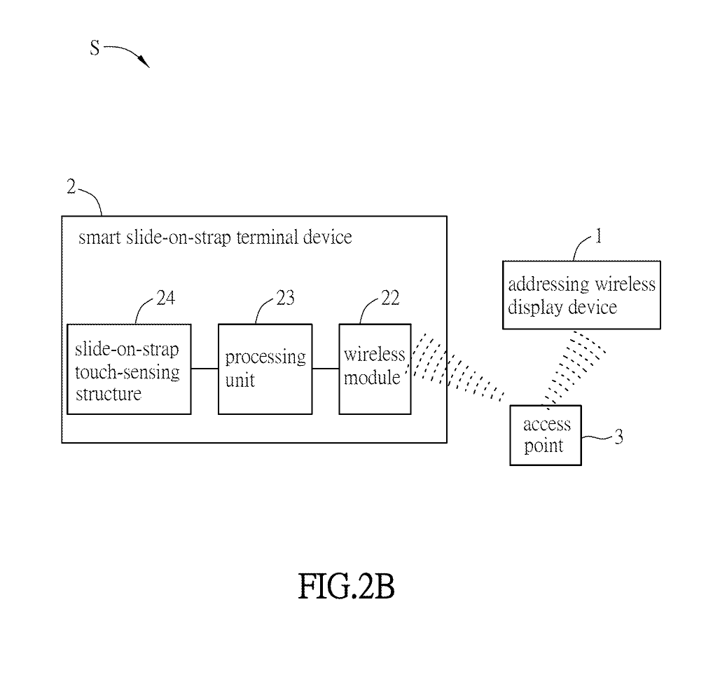

The smart slide-on-strap terminal device 2 communicates with the addressing wireless display device 1. FIG. 2A is a schematic enlarged diagram showing the smart slide-on-strap terminal device in FIG. 1. FIG. 2B is a schematic block diagram showing the smart slide-on-strap terminal device in FIG. 1. The smart slide-on-strap terminal device 2 of this embodiment is a smart watch to be described as an example, as shown in FIG. 1, FIG. 2A and FIG. 2B. Additionally, elements of the smart slide-on-strap terminal device 2 of this embodiment may be implemented by the combination of the hardware, software or firmware of one or multiple signal processing and/or integrated circuits.

The smart slide-on-strap terminal device 2 of this embodiment comprises a body 21, a wireless module 22, a processing unit 23 and at least one slide-on-strap touch-sensing structure 24. As mentioned hereinabove, the smart slide-on-strap terminal device 2 of this embodiment is a smart watch described as an example. The body 21 has a strap 211 and a housing 212. The strap 211 is connected to the housing 212, and the strap 211 is a portion that may be worn by the user. In other embodiments, the strap 211 is detachably connected to the housing 212, but it is not limited to the connection form. In details, the strap 211 of this embodiment may be a watchband of a smart watch, and may also be a strap of a smart bracelet or the portion of the necklace chain in other embodiments, and it is not limited thereto. Preferably, the length of the strap 211 is substantially equal to that of the hand circumference or foot circumference, so that the strap 111 can be worn by the user. In addition, the length of the strap 211 may also be adjustable so that the adjustment can be made according to the hand circumferences or foot circumferences for different user′ requirement.

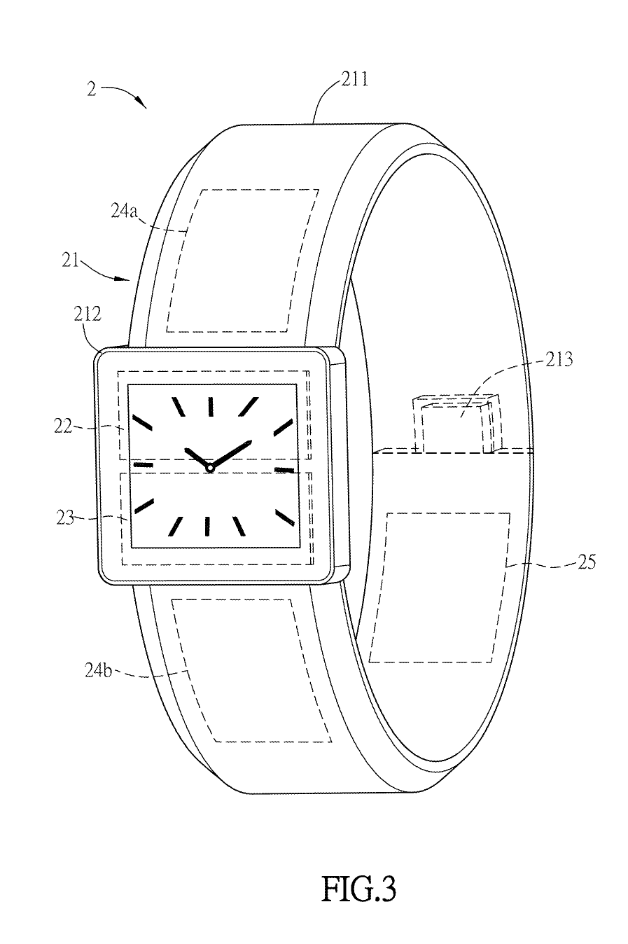

In addition, the wireless module 22 and the processing unit 23 of this embodiment are disposed on the body 21, and may be disposed on the strap 211 of the body 21 or inside the housing 212, but they are not limited thereto. The wireless module 22 and the processing unit 23 may be disposed inside the housing 212 of the body 21, and the wireless module 22 and the processing unit 23 are coupled to each other. The slide-on-strap touch-sensing structure 24 is disposed on the strap 211 to form that the slide-on-strap touch-sensing structure 24 is disposed on one side of the housing 212. In other embodiments, the smart slide-on-strap terminal device 2 may also have two slide-on-strap touch-sensing structures 24a and 24b, and are respectively disposed on two opposite sides of the strap 211 corresponding to the housing 212, as shown in FIG. 3. FIG. 3 is a schematic view showing another example of the smart slide-on-strap terminal device of the embodiment. It is noted that because the difference between the smart slide-on-strap terminal devices 2 of FIG. 3 and FIG. 2A only differ from the number of the slide-on-strap touch-sensing structures 24, so the symbols thereof are adopted. In details, the slide-on-strap touch-sensing structures 24a and 24b of this embodiment are respectively disposed on top and bottom sides of the housing 212.

The slide-on-strap touch-sensing structure 24 of this embodiment is a capacitive touch-sensing structure. When a conductor, such as a user's finger, touches the slide-on-strap touch-sensing structure 24, which will appear capacitance change to generate the corresponding signal at the contact position.t. In addition, the slide-on-strap touch-sensing structure 24 may comprise a driving circuit and a sensing circuit (Tx and Rx, which are well known in the art but not depicted in the drawing), and the material thereof may be an electro-conductive layer (a transparent electro-conductive layer, such as indium tin oxide (ITO), indium zinc oxide, fluorine doped tin oxide, aluminum doped zinc oxide (AZO) or gallium doped zinc oxide may be adopted), a nano wire layer, graphene, or a metal mesh. However, it is not limited thereto.

The driving circuit is disposed inside the strap 211, and the sensing circuit is disposed on an outer surface of the strap 211. A portion of the sensing circuit has a protrusion on the outer surface of the strap 211, and the strap 211 may further comprise a protection layer for covering the protrusion and thus protecting the sensing circuit. Besides, the user can obtain the position of the slide-on-strap touch-sensing structure 24 by touching the protrusion. In other words, indicating the position of the slide-on-strap touch-sensing structure 24 can be achieved by the sensing circuit of the protrusion. In other embodiments, the protrusion may further be designed to have a designate shape, such as an arrow shape or the like, for instructing the user to execute the touch operation.

Moreover, the wireless module 22 comprises an infrared module, a bluetooth module, a ZigBee module, a radio frequency module or a near-field communication module. Referring to FIG. 1 and FIG. 2B, the smart slide-on-strap terminal device 2 can communicate with the addressing wireless display device 1 by the wireless module 22. Preferably, the smart network system S further comprises a wireless access point 3 which communicates with the wireless module 22 of the smart slide-on-strap terminal device 2 and the addressing wireless display device 1 so the smart slide-on-strap terminal device 2 can communicate with the addressing wireless display device 1 through the wireless access point 3. In details, the wireless module 22 comprises a wireless communication chip and an antenna. The wireless communication chip is electrically connected to the processing unit 23, the antenna is disposed on the body or the slide-on-strap touch-sensing structure 24, and they are not limited thereto. In other embodiments, there may be multiple wireless modules 22 for performing short-distance data transmission with other electronic devices, or performing data transmission via the telecommunication or network signals.

The processing unit 23 is coupled to the wireless module 22 and the slide-on-strap touch-sensing structure 24. The processing unit 23 of this embodiment is a central processing unit (CPU) for example. The processing unit 23 may receive the signal generated when the slide-on-strap touch-sensing structure 24 is touched, produce the corresponding operation instruction, transmit the corresponding operation instruction to the wireless module 22, and then communicate with the addressing wireless display device 1 by the wireless module 22 and the wireless access point 3 to remotely control the addressing wireless display device. Therefore, the input operation instruction by the user can make the processing unit 23 control and transmit the display information, the display information can be transmitted to the wireless module of the addressing wireless display device 1 through the wireless access point 3 so that the addressing wireless display device 1 can show the display information. The display information corresponds to the operation instruction and it can be image information, graphic information or text information which is not limited thereto.

In detail, the slide-on-strap touch-sensing structure 24 is coupled to the processing unit 23 to permit the user to perform the touch operation on the slide-on-strap touch-sensing structure 24 by finger for example. The addressing wireless display device 1 can display the corresponding operation instruction according to the operating gesture of the user (or referred to as the hand gesture) through the processing unit 23 and the wireless module 22 to interact with the graphic user interface displayed on the addressing wireless display device 1.

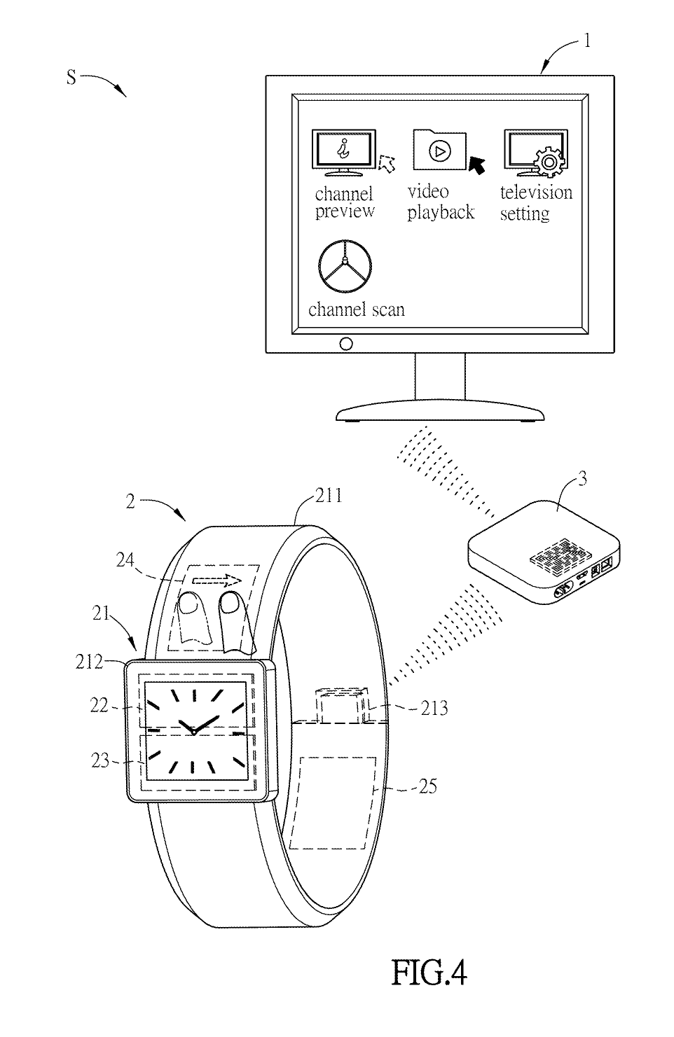

For example, when the user's finger slides on the slide-on-strap touch-sensing structure 24, the addressing wireless display device 1 also has a corresponding cursor (e.g., in the shape of an arrow or a hand) sliding at the corresponding position, as shown in FIG. 4. FIG. 4 is a schematic diagram showing operations of the slide-on-strap terminal device in FIG. 1. In addition, the interaction with the graphic user interface may be, for example, that the user adopts the finger to touch on the slide-on-strap touch-sensing structure 24 to perform the operation of tapping, volume adjusting or playback speed adjusting. For instance, when the user's finger taps on the slide-on-strap touch-sensing structure 24, the addressing wireless display device 1 executes the object corresponding to the position information, so as to directly control and execute the object displayed on the addressing wireless display device 1 by the slide-on-strap touch-sensing structure 24. Thus, the shadeless touch can be implemented. Herein, the so-called “touch” may comprise the operation of hand gesture or the other operation gesture, such as tapping once or tapping multiple times, sliding once or sliding multiple times (e.g., sliding from left to right, sliding from right to left, sliding upward or downward), the sequential tapping of multiple fingers, sliding of multiple fingers, or the like.

In one embodiment, if the wireless module 22 is the near-field communication module, then the near-field communication module may further comprise a user identification key, and automatically links the user identification key to the addressing wireless display device 1 by the wireless module 22 for the purpose of identification to restrict or manage the user (who holds the smart slide-on-strap terminal device 2) in manipulating the addressing wireless display device 1. The addressing wireless display device 1 of this embodiment may be disposed in house environment, a vehicle, a bank or at a doorway. However, it is not limited thereto.

In details, each touch operation can make the slide-on-strap touch-sensing structure 24 sense at least one trigger event, and transmits a signal, induced by the trigger event, to the processing unit 23, which analyzes the signal and processes the signal into a corresponding operation instruction. Next, the wireless module 22 receives the operation instruction from the processing unit 23, and transmits the operation instruction to the addressing wireless display device 1, so that the processing unit of the addressing wireless display device 1 can correspondingly execute the operation instruction. That is, the smart slide-on-strap terminal device 2 can remotely control the addressing wireless display device 1, and control contents displayed on the addressing wireless display device 1. The processing unit 23 of this embodiment may be constituted by a single processing chip or multiple processing chips, and can analyze the trigger event sensed by the slide-on-strap touch-sensing structure 24. The trigger event comprises a trigger quantity, a trigger quantity distribution, a trigger morphology (which can refer to trigger appearance), a trigger time, a trigger frequency or a trigger location (which can refer to trigger position). Operation instructions corresponding to various trigger events may be set as default status when the smart slide-on-strap terminal device 2 is shipped out, and may also be modified by the users according to their different using habits.

The processing unit 23 can produce the corresponding operation instruction according to a trigger time, a trigger track or a trigger frequency of the trigger event, wherein the trigger time is the time length during which the user's finger touches the slide-on-strap touch-sensing structure 24. For example, a short press (with the short trigger time) corresponds to a selecting operation, and a long press (with the long trigger time) corresponds to a confirmation operation. The trigger track represents a track path of a touch operation. Corresponding operation instructions may be generated according to the track paths by way of setting. The trigger frequency represents the frequency of the touch operations in a short time, and represents the user's tapping frequency on the slide-on-strap touch-sensing structure 24. The operation instruction may be correspondingly generated according to the designate tapping frequency by way of setting. Various embodiments will be described in the following.

In one embodiment, the trigger frequency of the trigger event conforms to a booting condition. That is, when the user's clicking frequency on the slide-on-strap touch-sensing structure 24 conforms to a booting condition, the processing unit 23 can correspondingly generate a booting operation instruction, and transmit the booting operation instruction to the addressing wireless display device 1 by the wireless module 22 so that the power is turned on and the addressing wireless display device 1 displays an image. In other words, the user can oneself set the click operation with the designate frequency as the booting condition. When the processing unit 23 receives the trigger event conforming to the booting condition, the addressing wireless display device 1 can be remotely controlled to execute the booting operation instruction. In other embodiments, it is also possible to set the following condition, in which when the trigger event occurs on the slide-on-strap touch-sensing structure 24 and the touch time (trigger time) is longer than or equal to a predetermined time, such as 5 seconds, the processing unit 23 can correspondingly produce the booting operation instruction, and remotely control the addressing wireless display device 1 to execute the booting operation instruction by the wireless module 22.

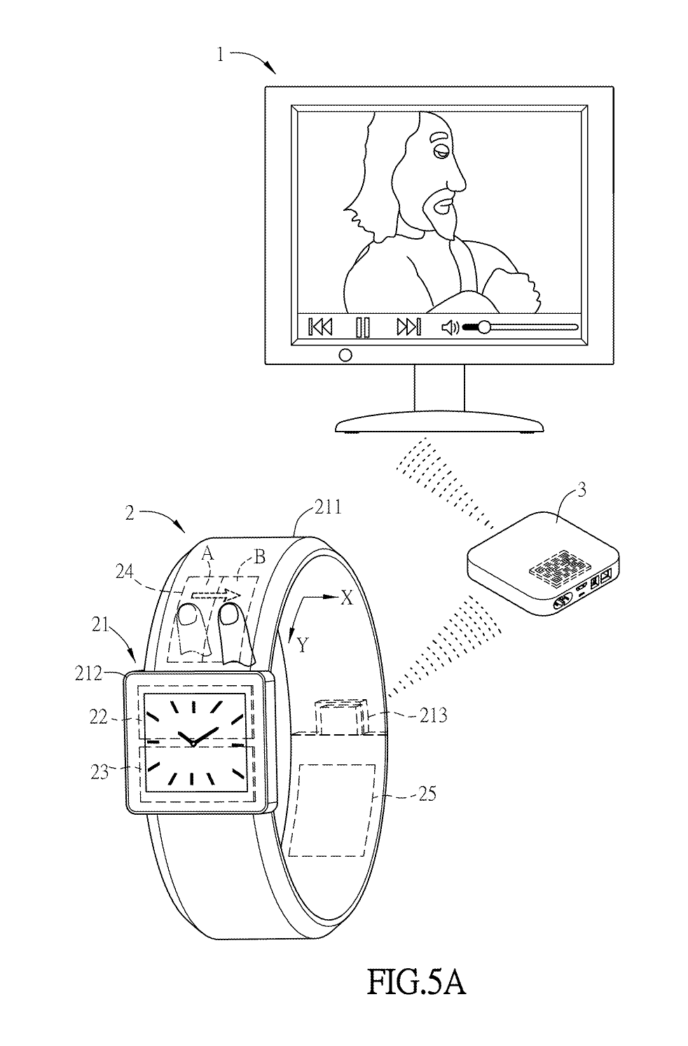

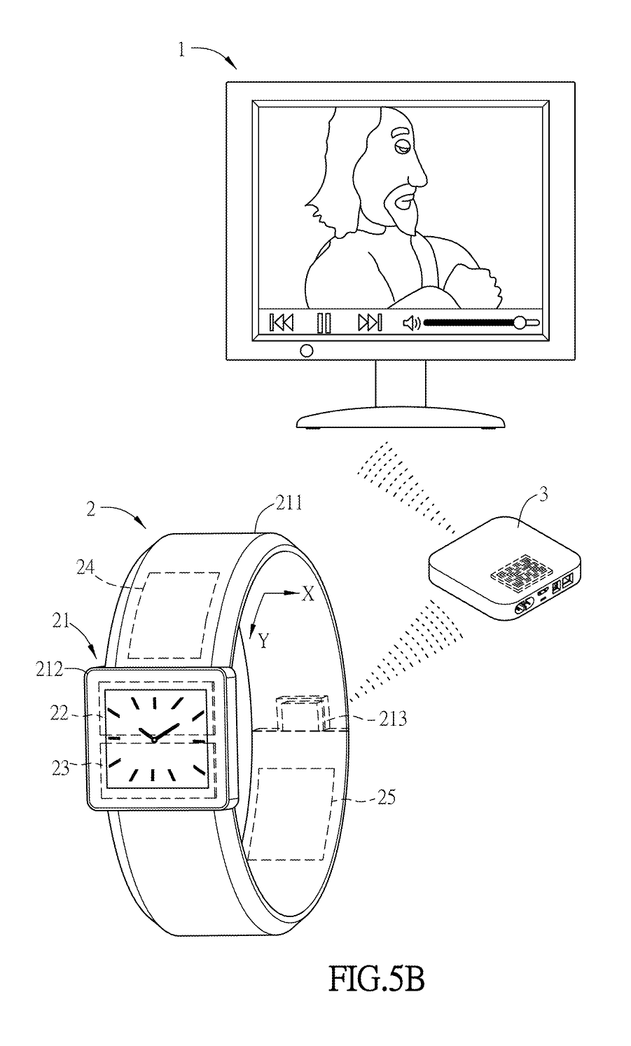

FIG. 5A and FIG. 5B are schematic diagrams showing operations of the slide-on-strap terminal device in FIG. 1. Referring to FIG. 2, FIG. 5A and FIG. 5B concurrently. In one embodiment, it is also possible to set the following condition. The processing unit 23 produces the operation instruction for increasing or decreasing the volume and remotely controls the addressing wireless display device 1 to execute the operation instruction for increasing or decreasing the volume through the wireless module 22 after the addressing wireless display device 1 booting. If the trigger event occurs on the slide-on-strap touch-sensing structure 24, the trigger time is longer than or equal to the preset predetermined time, which may be the same as (5 seconds) or different from (e.g., 1 second) that of the above-mentioned embodiment, and the trigger track is in one direction (i.e., the touch track path is substantially a straight line in one direction). In this embodiment, the trigger track sliding from the region A (left) to the region B (right) in the X direction is defined as the operation gesture for increasing the volume; and the trigger track sliding from the region B (right) to the region A (left) in the X direction is defined as the operation gesture for decreasing the volume. For example, as shown in FIG. 5A, when the user continuously touches the slide-on-strap touch-sensing structure 24 for 1 second, and the touch trigger track path slides from the region A (left) to the region B (right) in the X direction, the processing unit 23 produces the operation instruction for increasing the volume, and remotely controls the addressing wireless display device 1 to increase the volume by the wireless module 22, as shown in the volume region of FIG. 5B, wherein the black portion is increased. When the touch trigger track is executed on the contrary, the operation instruction for decreasing the volume is generated.

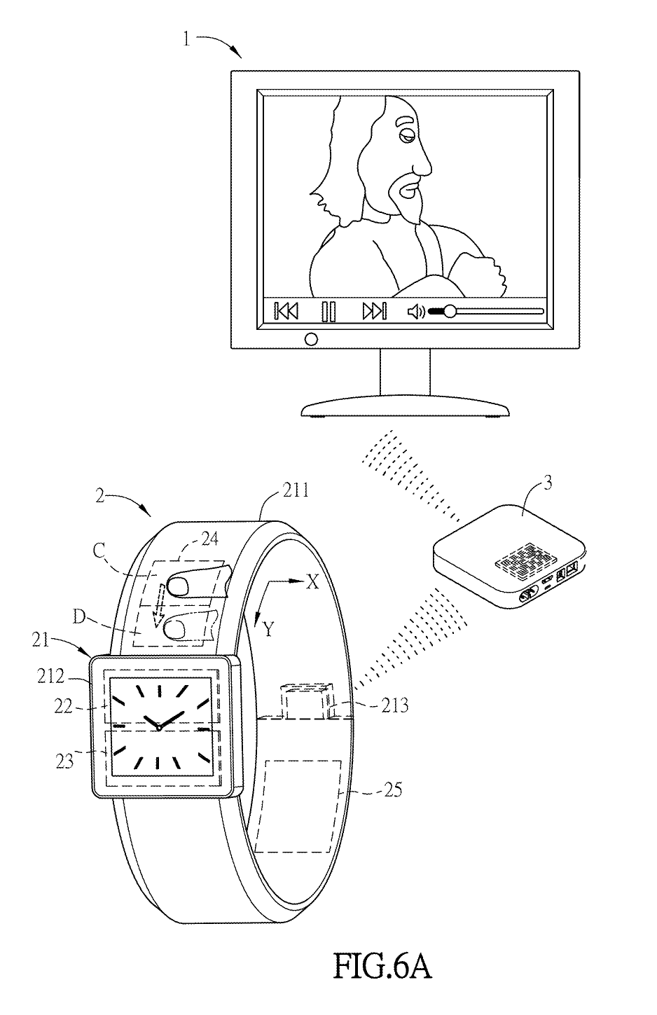

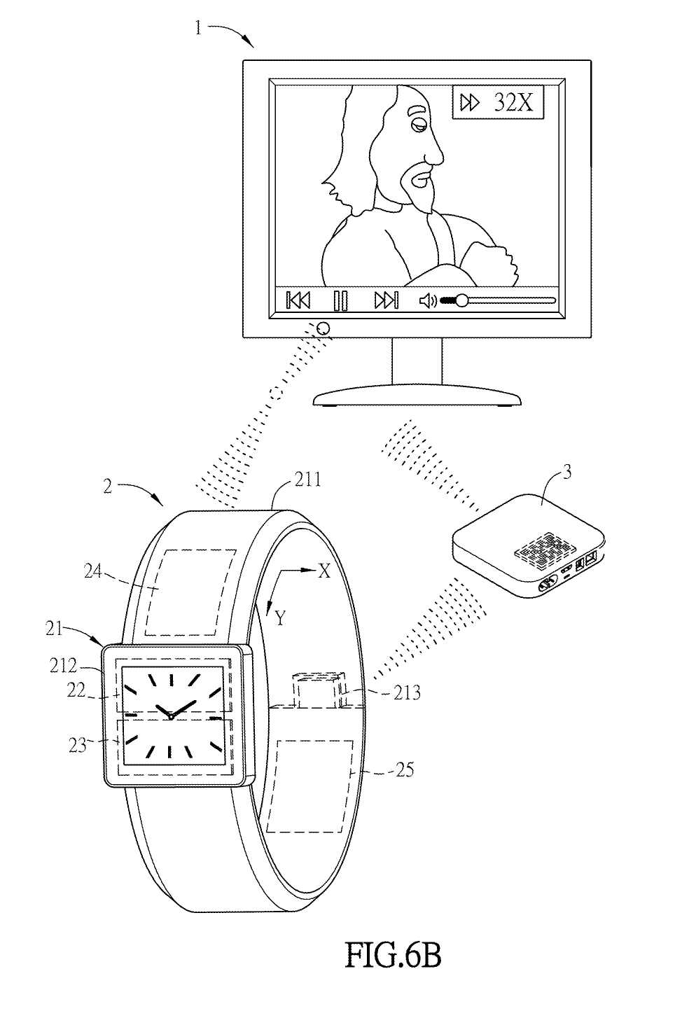

In one embodiment, it is also possible to set the operation instruction for increasing or decreasing the playback speed additionally. FIG. 6A and FIG. 6B are schematic diagrams showing operations of the slide-on-strap terminal device in FIG. 1. Referring to FIG. 2B, FIG. 6A and FIG. 6B concurrently. In details, it is possible to set the condition, in which when the user touches the slide-on-strap touch-sensing structure 24 continuously for 1 second, and the touch track path slides from the region C (up) to the region D (down) in the Y direction, such the touch gesture is defined as increasing the playback speed, and the gesture from top to bottom in each operation can be defined as increasing the current playback speed to 2 times of speed (2×). So, the 32 times of speed (32×) of FIG. 6B is set when the user operates the gesture from top to bottom by 5 times (the operations of several times sequentially correspond to 2×, 4×, 8×, 16× and 32×). On the contrary, when the user touches the slide-on-strap touch-sensing structure 24 continuously for 1 second, and the touch track path slides from the region D (down) to the region C (up) in the Y direction; such touch gesture is defined as decreasing the playback speed.

In other embodiments, it is also possible to set the condition, in which when the trigger event occurs on the slide-on-strap touch-sensing structure 24, and the trigger track is composed of multiple single-direction tracks (i.e., the user's fingers touch the slide-on-strap touch-sensing structure 24), the processing unit 23 can correspondingly generate a one-dimensional screen scrolling operation instruction for switching to a next frame. Preferably, the one-dimensional screen scrolling direction is the same with the direction of the multiple trigger tracks. Such the operation method can be applied to a user for browsing of document or webpage, or reading the mails. However, it is not limited thereto.

Besides, in the embodiments of multiple slide-on-strap touch-sensing structures, the received trigger events by different slide-on-strap touch-sensing structures may correspondingly produce different operation instructions. In one embodiment, a central line may also be defined on the surface of the strap 211 to divide the slide-on-strap touch-sensing structure 24 into two touch-sensing areas (see the region A and the region B of FIG. 5A) to simulate the functions of two physical buttons of the mouse (e.g., the ENTER button for confirmation or Selection button for a menu function), so that more touch input methods and their corresponding operation instructions can be defined on the smart slide-on-strap terminal device 2.

In one embodiment, one end of the strap 211 has a signal port 213, which is coupled to the processing unit 23 and can be applied to data transmission or power transmission to perform charging. In other embodiments, a battery may be provided. In the embodiment, the charging module 25 is provided and disposed on the housing 212 or the strap 211 for wireless charging. In details, the wireless access point 3 can transmit a wireless charging energy to the charging module 25. The charging module 25 can comprise at least one charging coil, a rectifier and a voltage regulating circuit. The rectifier and the voltage regulating circuit are coupled to the processing unit 23. The wireless access point 3 transmits a wireless charging energy so as to change the magnetic field and electric field around the smart slide-on-strap terminal device 2. Thus, the electric energy can be generated in the charging coil and provided the smart slide-on-strap terminal device 2 charging ability through the rectifier and the voltage regulating circuit.

In other embodiments, a wireless signal may be transmitted and the wireless charging energy from a wireless charging device (for example the wireless access point 3) may be received through the wireless module 22 synchronously. The wireless charging energy can be disposed in a vehicle, in a bank, in a home appliance or at a doorway. The wireless charging energy comes from a wireless access point, a display, a television or a monitor for wireless charging. However, it is not limited thereto. In other embodiments, one end of the strap 21 has a signal port which is coupled to the processing unit 23 and can be applied to data transmission or power transmission to perform charging.

In one embodiment, the wireless access point 3 can further comprise a high-frequency oscillator. After the power signal being converted to a high-frequency signal by the high-frequency oscillator, the high-frequency signal is transmitted to the charging module. After the energy being transmitted to the charging module, it is converted to a direct current (DC) by the rectifier and provided for the smart slide-on-strap terminal device 2 to charge. In one embodiment, the wireless access point 3 can further comprise a magnetically coupled resonators which utilizes the principle that two resonance objects of the same frequency can produce strong reciprocal coupling, so that two coils characterized by LC Resonant circuit load a coil of the wireless access point 3 with several MHz alternating current resulting in an electromagnetic field around it. By the resonance due to the Electromagnetic induction between the two coils, power is delivered to another coil at the smart slide-on-strap terminal device 2. Thus, wireless power transmission is achieved to charge the smart slide-on-strap terminal device 2.

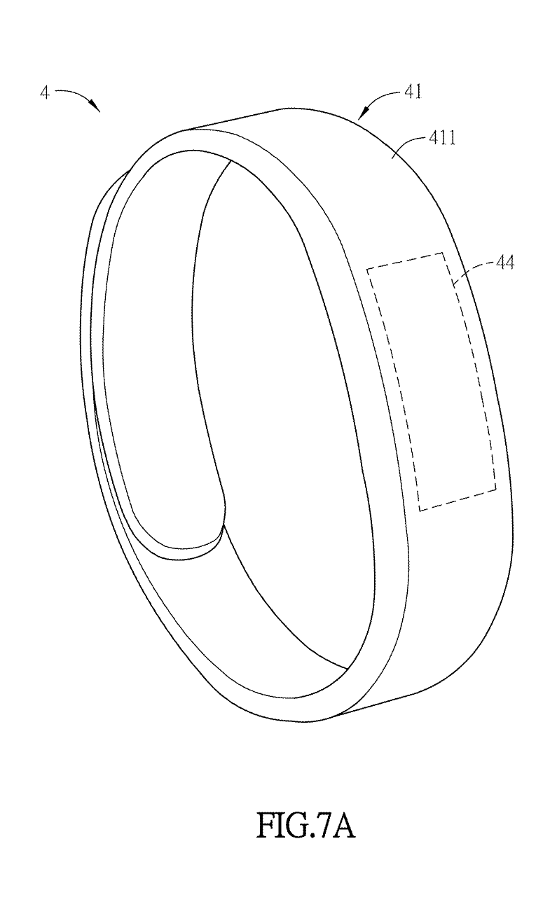

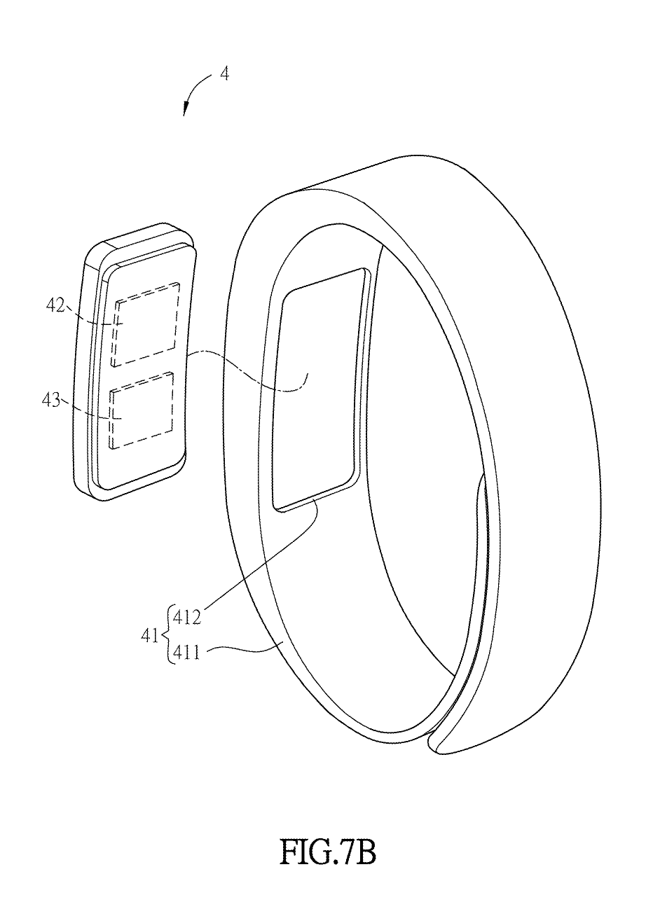

In one embodiment, the smart slide-on-strap terminal device 4 can be applied to a smart bracelet. Referring to FIG. 7A and FIG. 7B, FIG. 7A is a schematic diagram showing the smart slide-on-strap terminal device according to another embodiment of the invention, and FIG. 7B is a schematic exploded diagram showing the smart slide-on-strap terminal device in FIG. 7A. The smart slide-on-strap terminal device 4 is a smart bracelet. The wireless module 42 and the processing unit 43 are disposed on the strap 411 of the body 41. In details, the body 41 is mainly composed of the strap 411 which may be a strap of a smart bracelet. In one embodiment, the wireless module 42 and the processing unit 43 are disposed on the strap 411. In the embodiment, the body 41 further has a slot 412. The wireless module 42 and the processing unit 43 are detachably disposed inside the slot 412. The slide-on-strap touch-sensing structure 44 is disposed on the outer surface of the strap 411 so that the user can perform the touch input on the slide-on-strap touch-sensing structure 44 to remotely control other addressing wireless display device 1 (referring to FIG. 1).

In other embodiments, the smart network system can be applied to a smart necklace, and the strap of the body can be the chain of the smart necklace. Similarly, the main portion of the body can have a slot for accommodating the wireless module and the processing unit, and the slide-on-strap touch-sensing structure is disposed on the outer surface of the strap (chain) so that the user can perform the touch input on the slide-on-strap touch-sensing structure to remotely control other addressing wireless display device 1.

In summary, in the smart network system, the smart slide-on-strap terminal device communicates with the addressing wireless display device so that the user can perform the touch input by operating the smart slide-on-strap touch-sensing terminal device. The user can perform the touch operation on the slide-on-strap touch-sensing structure disposed on the strap. Next, the processing unit produces the corresponding operation instruction, and the wireless module transmits the operation instruction to the addressing wireless display device to remotely control the addressing wireless display device. In other words, the smart slide-on-strap terminal device may be utilized as the smart remote controller to enhance the functions possessed by the smart slide-on-strap terminal device. The design of the slide-on-strap touch-sensing structure may also needs no more physical buttons, and the overall integrity of the outlook of the slide-on-strap touch-sensing structure can be maintained. In addition, because the element of performing the touch operation is almost on the slide-on-strap touch-sensing structure, the conventional physical button can be replaced, and the overall integrity and beauty of the outlook of the smart slide-on-strap terminal device can be upgraded, and the higher quality and more wonderful user experience can be implemented.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A smart network system, comprising:
at least one addressing wireless display device; and
a smart slide-on-strap terminal device, communicating with the addressing wireless display device, comprising:
a body, having a strap;
a wireless module, disposed on the body;
a processing unit, coupled to the wireless module; and
at least one slide-on-strap touch-sensing structure, disposed on the strap and coupled to the processing unit, and sensing at least one trigger event to remotely control the addressing wireless display device.

2. The smart network system of claim 1, wherein the smart slide-on-strap terminal device comprises a smart bracelet, a smart watch, or a smart ring.

3. The smart network system of claim 2, wherein the strap comprises a watchband of the smart watch, a strap of the smart bracelet or a circle of the smart ring.

4. The smart network system of claim 1, wherein the slide-on-strap touch-sensing structure is a capacitive touch-sensing structure.

5. The smart network system of claim 1, wherein a central line is disposed on a surface of the strap to divide the slide-on-strap touch-sensing structure into two touch-sensing areas to simulate functions of two physical buttons of a mouse.

6. The smart network system of claim 1, wherein the trigger event comprises a trigger quantity, a trigger quantity distribution, a trigger morphology, a trigger time, a trigger location or a trigger frequency.

7. The smart network system of claim 1, wherein the processing unit receives a signal generated by the trigger event to execute an operation instruction

8. The smart network system of claim 7, wherein the wireless module receives and transmits the operation instruction to the addressing wireless display device

9. The smart network system of claim 7, further comprising:
a wireless access point, communicating with the smart slide-on-strap terminal device and the addressing wireless display device, wherein the wireless module of the smart slide-on-strap terminal device transmits a display information corresponding to the operation instruction to the wireless access point, and the wireless access point transmits the display information to the addressing wireless display device.

10. The smart network system of claim 7, wherein the processing unit produces the operation instruction according to a trigger time, a trigger track or a trigger frequency of the trigger event.

11. The smart network system of claim 7, wherein if the trigger event occurs on the slide-on-strap touch-sensing structure, the trigger time is longer than or equal to a predetermined time, and the trigger track corresponds to one direction, then the processing unit produces the operation instruction of increasing or decreasing a volume.

12. The smart network system of claim 7, wherein if the trigger event occurs on the slide-on-strap touch-sensing structure, the trigger time is longer than or equal to a predetermined time, and the trigger track corresponds to one direction, then the processing unit produces the operation instruction of increasing or decreasing a playback speed.

13. The smart network system of claim 7, wherein if the trigger event occurs on the slide-on-strap touch-sensing structure, the trigger track comprises multiple trigger tracks having more than one direction, then the processing unit produces the operation instruction of one-dimensional screen scrolling, wherein a direction of the one-dimensional screen scrolling is the same with the direction of multiple trigger tracks.

14. The smart network system of claim 7, wherein if the trigger frequency of the trigger event conforms to a booting condition, then the processing unit produces an operation instruction of booting.

15. The smart network system of claim 1, wherein the wireless module comprises an infrared module, a bluetooth module, a ZigBee module, a radio frequency module or a near-field communication module.

16. The smart network system of claim 15, wherein the near-field communication module comprises a user identification key automatically linking to the addressing wireless display device by the wireless module.

17. The smart network system of claim 1, wherein the wireless module comprises a wireless communication chip and an antenna, the wireless communication chip is electrically connected to the processing unit, and the antenna is disposed on the body or the slide-on-strap touch-sensing structure.

18. The smart network system of claim 1, wherein the smart slide-on-strap terminal device comprises a charging module, and the wireless access point transmits a wireless charging energy to the charging module.

19. The smart network system of claim 1, wherein the slide-on-strap touch-sensing structure comprises a driving circuit and a sensing circuit, the driving circuit is disposed inside the strap, and the sensing circuit is disposed on an outer surface of the strap.

20. The smart network system of claim 19, wherein a portion of the sensing circuit on the outer surface of the strap has a protrusion, and the strap further comprises a protection layer covering the protrusion.
